(19) United States
(12) Patent Application Publication
(10) Pub. No.: US 2011/0007519 A1
(43) Pub. Date: Jan. 13, 2011

(54) ROTATABLE VEHICULAR LAMP

(75) Inventor: Jiun-Jiang WANG, Changhua (TW)

Correspondence Address: BROWDY AND NEIMARK, P.L.L.C.;624 NINTH STREET, NW, SUITE 300, WASHINGTON, DC, 20001-5303, US

(73) Assignee: MAXZONE AUTO PARTS CORP., Fontana, CA (US)

(21) Appl. No.: 12/833,139

(22) Filed: Jul. 9, 2010

(30) Foreign Application Priority Data
Jul. 10, 2009 (TW) 98212606

(51) Int. Cl. F21V 21/30

(52) U.S. Cl. 362/523

(57) ABSTRACT

A rotatable vehicular lamp is comprising a support member, a lamp unit, a linking member, and a driving unit. The lamp unit is pivotably connected with the support member on at least one first pivot. The linking member includes a first connection portion and a second connection portion both extending toward opposite directions respectively. The first connection portion is pivotably connected with the lamp unit on a second pivot. The driving unit is mounted to the support member and includes a working member pivotably and retractably connected with the second connection portion on a third axis. The working member can be linking-up with the second pivot and the lamp unit to swivel on the first axis. Accordingly, the whole operating stability and smoothness of the rotatable vehicular lamp can be enhanced.

### BACKGROUND OF THE INVENTION

1. Field of the Invention

The present invention relates generally to a vehicular lamp, and more particularly, to a rotatable vehicular lamp.

2. Description of the Related Art

Referring to FIG. 1, a conventional multi-axis swivel mechanism includes a support body 11, a headlamp unit 12, a headlamp bracket 13 annularly fixed to the headlamp unit 12 and inserted through the support body 11 on a first axis X1, and a driving unit 14 fixed to the support body 11. The headlamp bracket 13 has a receiving port 131. The driving unit 14 has a ball joint 141 slidably mounted to the receiving port 131 along a second axis X2, and a motor 142 for driving extension and retraction of the ball joint 141.

When the motor 142 drives the ball joint 141 for retraction or extension, the headlamp bracket 13 and the headlamp unit 12 can be moved at the same time through the receiving port 131 on the first axis X1 to turn left or right for the purpose of driving rotation of the headlamp unit 12.

When the headlamp unit 12 is rotated, the angle of the headlamp bracket 13 with respect to the second axis X2 can be changed. For this reason, in the process of retraction of the ball joint 141, the receiving port 131 is a linear slideway for providing sufficient space for movement of the ball joint 141. However, the receiving port 131 and the ball joint 141 are subject to mutual interference, non-smooth rotation, producing noises, etc. due to the conflict of the their actions. Besides, for the purpose of supporting the headlamp unit 12 and driving rotation of the headlamp unit 12, the headlamp bracket 13 is additionally installed. Therefore, the conventional multi-axis swivel mechanism is defective because of high production cost and complex structure and assembly procedure.

### SUMMARY OF THE INVENTION

The primary objective of the present invention is to provide a rotatable vehicular lamp, which operating stability and smoothness can be enhanced.

The foregoing objective of the present invention is attained by the rotatable vehicular lamp comprising a support member, a lamp unit, a linking member, and a driving unit. The lamp unit is pivotably connected with the support member on at least one first pivot. The linking member includes a first connection portion and a second connection portion both extending toward opposite directions respectively. The first connection portion is pivotably connected with the lamp unit on a second pivot. The driving unit is mounted to the support member and includes a working member pivotably and retractably connected with the second connection portion on a third pivot. The working member can be linking-up with the second pivot and the lamp unit to swivel on the first pivot.

By means of the aforesaid three pivots, the support member, the lamp unit, and the driving unit do not need sufficient space for movement and can be pivotably connected with one another so as to enhance the operating stability and smoothness of the whole rotatable vehicular lamp.

### BRIEF DESCRIPTION OF THE DRAWINGS

FIG. 1 is a perspective view of the prior art.

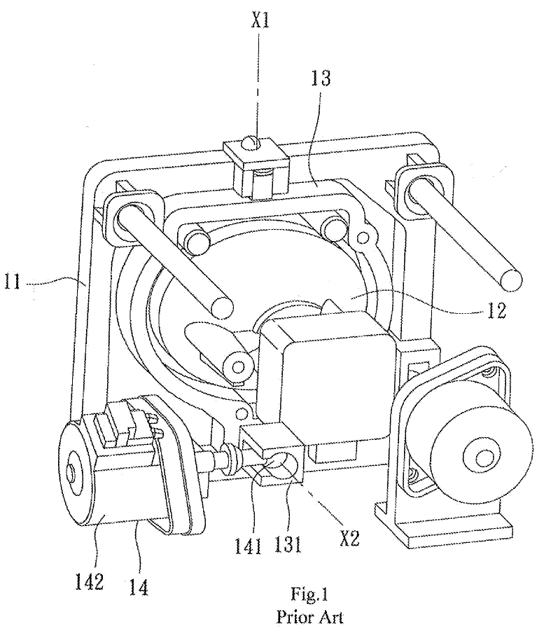

FIG. 2 is an exploded view of a preferred embodiment of the present invention.

FIG. 3 is a perspective view of the first preferred embodiment of the present invention.

FIG. 4 is a bottom view of the first preferred embodiment of the present invention.

FIG. 5 is a bottom view of the first preferred embodiment of the present invention while it is rotated.

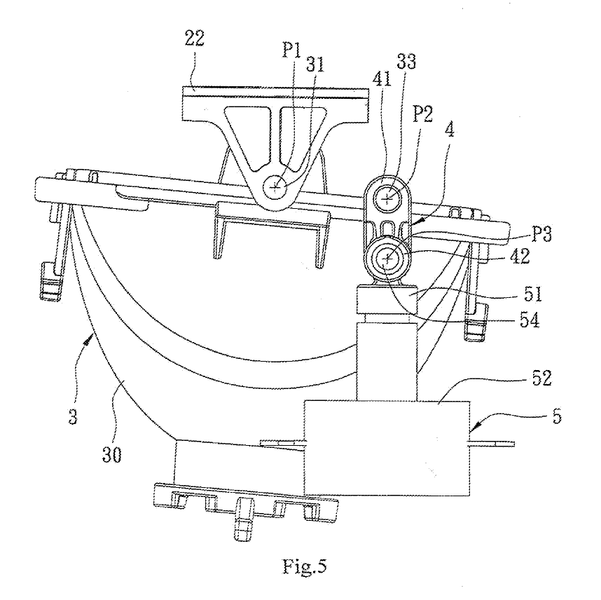

FIG. 6 is another bottom view of a second preferred embodiment of the present invention while it is rotated.

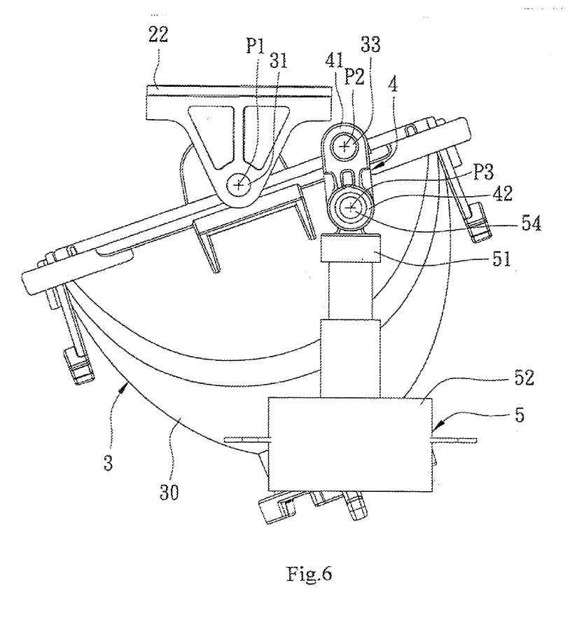

### DETAILED DESCRIPTION OF PREFERRED EMBODIMENTS

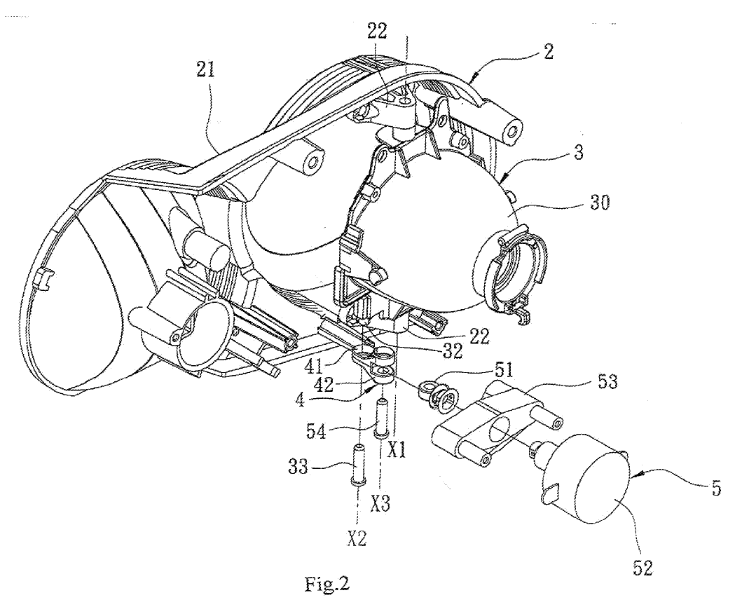

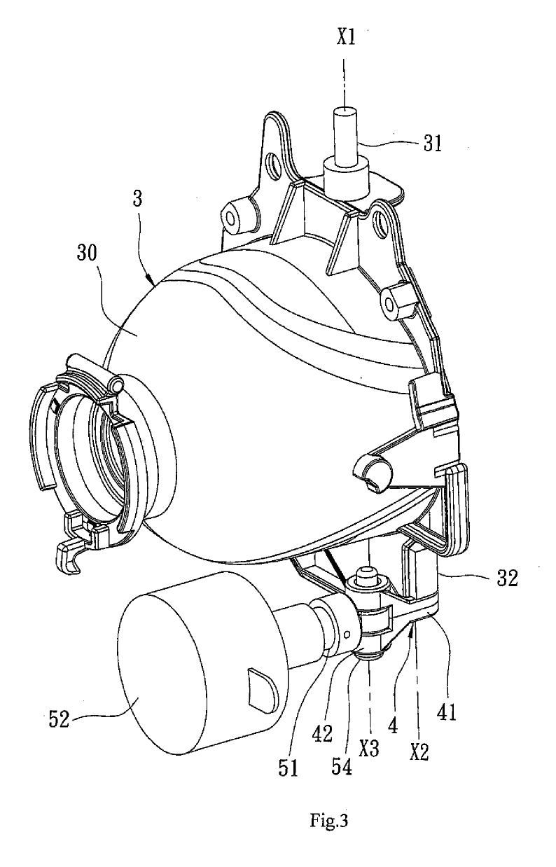

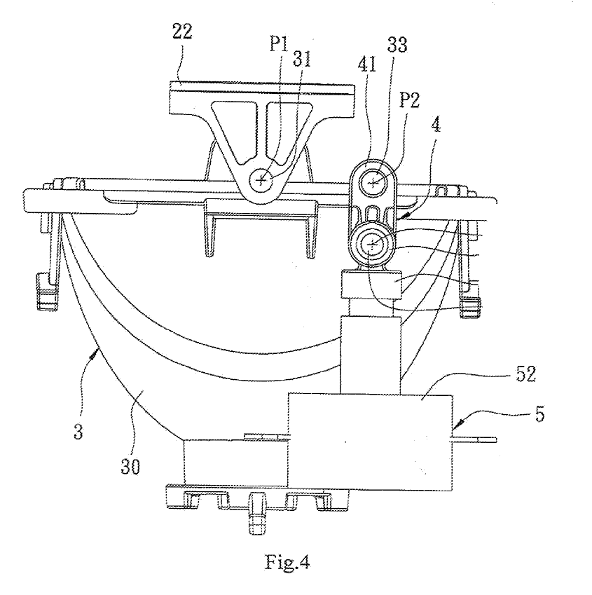

Referring to FIGS. 2-4, the rotatable vehicular lamp comprising a support member 2, a lamp unit 3, a linking member 4, and a driving unit 5. The detailed descriptions and operations of these elements as well as their interrelations are recited in the respective paragraphs as follows.

The support member 2 includes a mounting portion 21 for connection with a vehicle (not shown), and two pivot portions 22 mounted to two opposite sides of the mounting portion 21 separately.

The lamp unit 3 includes a housing 30, two first bolts 31, a holder 32, and a second bolt 33. The first bolts 31 are located on the first axis X1 and at opposite sides of the housing 30 separately and inserted through the two pivot portions 22 separately to define two first pivots P1. The holder 32 is formed on an eccentric position of the housing 30 along a second axis X2.

The linking member 4 is Y-shaped in this embodiment and includes a first connection portion 41 and a second connection portion 42, both of which extend toward opposite directions separately. The first connection portion 41 overlaps the holder 32 in such a way that the second bolt 33 can be inserted through the first connection portion 41 and the holder 32 along the second axis X2 to be pivotably connected with the housing 30 on a second pivot P2. It is to be noted that the first pivots P1 are centered on the first axis X1 and the second pivot P2 is centered on the second axis X2; the first axis X1 is parallel to the second axis X2.

The driving unit 5 includes a working member 51 pivotably connected with the second connection portion 42 on a third pivot P3, a motor 52 for driving the working member 51 for extension and retraction, a bracket 53 holding the motor 52 and fixed to the mounting portion 21, and a third bolt 54 inserted through the second connection portion 42 and the working member 51 along a third axis X3. The moving direction of the working member 51 is perpendicular to the second axis X2, and the working member 51 can be extended from the rear side toward the front side of the support member 2. The third axis X3 is parallel to the first and second axes X1 and X2.

Referring to FIGS. 2 & 4-6, when the motor 52 drives the working member 51 for extension or retraction from a predetermined position, the housing 30 can be moved through the linking member 4 at the same time, and the linking member 4 can change the angle of pivotal connection between the lamp unit 3 and the working unit 51 by means of the relationship of pivotal connection among the first and second connection portions 41 and 42, the lamp unit 3, and the working member 51 on the second and third pivots P2 and P3 to enable the second pivot P2 to shift on the first pivot P1 along with the change of location of the working member 51 and meanwhile to move the lamp unit 3 to rotate on the first pivot P1.

In conclusion, the present invention includes the following advantages. The aforesaid three pivots enable the support member 2, the lamp unit 3, and the working member 51 to keep pivotal connection with one another, such that they do not need sufficient space for movement and can be pivotably connected with another without any interference thereamong. In this way, the operating smoothness and stability of the present invention can be enhanced and the noises of the same can be reduced. Besides, the present invention only needs one linking member 4 for connection with the support member 2, the lamp unit 3, and the working member 51 and to drive rotation of the lamp unit 3, thus simplifying the whole structure and the assembly procedure and decreasing the production cost.

Although the present invention has been described with respect to a specific preferred embodiment thereof, it is in no way limited to the specifics of the illustrated structures but changes and modifications may be made within the scope of the appended claims.

What is claimed is:

1. A rotatable vehicular lamp comprising:
a support member;
a lamp unit pivotably connected with at least one first pivot;
a linking member having a first connection portion and a second connection portion, the first connection portion being pivotably connected with the lamp unit on a second pivot; and
a driving unit mounted to the support member and having a working member pivotably and retractably connected with the second connection portion, the working member being linking-up with the second pivot and the lamp unit on the first pivot.

2. The rotatable vehicular lamp as defined in claim 1, wherein the first and second pivots are centered on the first and second axes respectively, the first axis being parallel to the second axis, the moving direction of the working member being perpendicular to the second axis.

3. The rotatable vehicular lamp as defined in claim 2, wherein the lamp unit comprises two first pivots, a housing, and two first bolts located at two opposite sides of the housing respectively and inserted through the support member along the first axis to define a first pivot.

4. The rotatable vehicular lamp as defined in claim 2, wherein the lamp unit comprises a housing, a holder located on an eccentric position of the housing along the second axis, and a second bolt inserted through the holder and the first connection portion along the second axis.

5. The rotatable vehicular lamp as defined in claim 2, wherein the driving unit further comprises a third bolt inserted through the second connection portion and the working member along a third axis, the third axis being parallel to the first and second axes respectively.

6. The rotatable vehicular lamp as defined in claim 1, wherein the driving unit further comprises a motor for driving extension and retraction of the working member, and a bracket holding the motor and fixed to the support member.
